(19) United States
(12) Patent Application Publication
(10) Pub. No.: US 2022/0063178 A1
(43) Pub. Date: Mar. 3, 2022

(54) ANTIVIRAL AND ANTIMICROBIAL PROTECTIVE FILMS WITH MICROSTRUCTURE DETERRENTS COMBINED WITH THERMALLY ELASTOMERIC AND EMBEDDED CHEMICAL ANTI-BACTERIAL OR ANTI-VIRAL AGENTS

(71) Applicant: Lumenco, LLC, Englewood, CO (US)

(72) Inventors: Mark A. Raymond, Littleton, CO (US); Hector Andres Porras Soto, Littleton, CO (US); Michael German, Centennial, CO (US)

(21) Appl. No.: 17/411,668

(22) Filed: Aug. 25, 2021

Related U.S. Application Data
(60) Provisional application No. 63/071,624, filed on Aug. 28, 2020.

(51) Int. Cl. B29C 59/02; B29C 59/04; B29C 59/00; B08B 17/06

(52) U.S. Cl. CPC B29C 59/022; B29C 59/046; B29C 59/005; B29K 2301/12; B29C 59/002; B29C 2059/023; B08B 17/06

(57) ABSTRACT

An antimicrobial protective film that can be applied to a surface such as a screen of a smartphone or computing device. The user is able to view items displayed on the screen and to interact with the screen via touch or the like. The protective film includes a base layer or film upon which a second layer is formed, and this second layer includes numerous structures, e.g., micro or nano structures. The structures have a geometry that is unfriendly for viruses and bacteria. The structures are embedded with antimicrobial and/or antiviral agents that migrate out of the structures and kill or at least detrimentally affect the viruses or bacteria received within the second layer. This effect is combined with the fact that the structures are made with geometries particularly devastating to microbes during elongation and contraction of the structures with the thermal-based expansion and contraction of the underlying base layer.

### REFERENCE TO RELATED APPLICATIONS

This application claims priority to U.S. Provisional Patent Appl. No. 63/071,624, filed on Aug. 28, 2020, which is incorporated herein in its entirety by reference.

### BACKGROUND

### 1. Field of the Description

The present description relates, in general, to design and fabrication of films for application to surfaces such as electronic device screens and the like to protect users from virus, bacteria, and the like, and, more particularly, to antiviral and antimicrobial protective films, and methods of manufacturing and using such films.

### 2. Relevant Background

With the advent of recent worldwide pandemics, there is a rapidly growing need and demand for ways to prevent or limit growth and transfer of viruses and bacteria that cause illness to and between humans. As one example, it has become apparent that frequently touched surfaces of commonly used devices, such as touchscreens, smartphone exterior surfaces and screens, personal computing devices and their screens, keypads, and so on, can provide havens for viruses and bacteria. Then, a simple touch by a user can transfer those contaminants to the user (and then other individuals) as they later touch their nose or eyes, which can cause them to become ill. Many smooth surfaces, such as exterior portions of smartphones, countertops, doors, and so on can hold viruses and bacteria for long periods of time before perishing.

A number of approaches have been tried to protect people from being exposed through contact with surfaces, but none have been fully adopted or effective, and there remains a need for solutions that do not interfere with functionality or aesthetics while also killing viruses and bacteria. For example, antimicrobial surface have been used, in hospitals and other locations to limit infections, and these surfaces contain an antimicrobial agent that inhibits the ability of microorganisms to grow on the surface of a material. Antimicrobial surfaces are functionalized in a variety of different processes. A coating may be applied to a surface that has a chemical compound which is toxic to microorganism. Other surfaces have been designed that use antimicrobial materials such as copper and its alloys, which are natural antimicrobial materials that have intrinsic properties to destroy a wide range of microorganisms. While being useful in some settings, existing antimicrobial surfaces have not been effective against all viruses and bacteria and, in some cases, have proven to not be effective over long periods of use, which requires maintenance or replacement that can be expensive and inconvenient for users.

### SUMMARY

To address limitations with prior protective surface designs, a protective film was designed by the inventors that is antimicrobial and/or antiviral and, in some embodiments, does not interfere with the functionality of the underlying device or its surface. For example, the new protective film may be transparent or at least translucent to light and can be applied to a screen (e.g., a touchscreen) of a smartphone or computing device, and the user is able to view items displayed on the screen and to interact with the screen via touch or the like.

The protective film includes a base layer or film (sometimes referred to as a first layer or structure-supporting layer (or film)) upon which a second layer is formed, and this second layer or film includes numerous structures or microstructures. The microstructures are made or designed to have a geometry that is unfriendly for attachment of viruses and/or bacteria. The microstructures are embedded, in some embodiments, with antimicrobial and/or antiviral agents that migrate out of the material of the structures and kill or at least detrimentally affect the viruses or bacteria received within the second layer or film. To this end, the structures may be made with geometries that are particularly devastating to the viruses and bacteria during elongation and contraction of the structures, e.g., the expansion and shrinkage of the structural elements/components can rip or cut apart the viruses and bacteria.

The underlying film or first layer can be formed of a thermally elastic material so that the first layer changes with temperature so as to expand and contract with even relatively small or minor temperature changes (e.g., less than 20° F. variance with some materials expanding and contracting adequately to provide the desired functionality with changes in the range of 1 to 5° F.). The structures supported upon this first layer (in the second layer) move with the supporting materials so that they too elongate and contract with temperature changes, thereby breaking apart or otherwise damaging viruses and bacteria contacting such structures (e.g., received at least partially within recessed surfaces (or cracks and canyons) of the structures).

The protective film is then applied (e.g., with a transparent adhesive) to a surface that is to be protected from viruses and bacteria such as a screen of a computing or electronic device. Screens and other surfaces of display devices, computing devices, smartphones, and the like often experience a relatively large change in temperature (e.g., 10 to 20 F or more) during their use, e.g., during charging, when changing use environments such as from car to office to home, and so on. These temperature changes cause the first layer (or structure supporting film), with its thermally unstable materials, to elongate and/or contract, which, in turn, causes the elongation and contraction of the second layer/film and the structures contained therein.

More particularly, a protective film is described herein for providing antiviral and antibacterial protection. The protective film includes a first layer comprising a thermally elastic material, and the first layer undergoes elongation or contraction when the protective film is exposed to a temperature differential (e.g., one of at least about 5° C.). The protective film also includes a second layer disposed upon the first layer comprising a plurality of structures with surfaces for receiving at least one of viruses and bacteria. The structures of the second layer undergo elongation or contraction in response to the elongation or contraction of the first layer, and, further, the structures are configured to damage the viruses or the bacteria upon movement of the surfaces during the elongation or contraction of the structures.

In some embodiments, the structures each have a height in the range of 1 to 10 microns, a width in the range of 1 to 30 microns, and a length in the range of 1 to 100 microns. In such embodiments, the structures may have a randomly generated geometry and can be arranged in a non-repeating pattern. Alternatively, the structures may be arranged in nonparallel and non-repeating patterns within 50 to 100 microns of the X and Y axes. In some other embodiments, the second layer is provided as a layer of nanoporous anodic aluminum oxide (AAO).

In some film implementations, the thermally elastic material is a material with a linear thermal coefficient differential of at least 5° C. For example, the thermally elastic material may include at least one of: polytetrafluoroethylene (PTFE), plasticized polyvinyl chloride (PVC), plasticized filled PVC, PVC rigid, and polyvinylidene chloride (PVDC). In some cases, the thermally elastic material is a material having thermal expansion or contraction in at least one dimension or axis of at least 0.01% when the temperature differential is 5° C. or greater. In these and other cases, the second layer is formed of a film or layer of UV material.

In some preferred embodiments, the second layer is formed of a material including an additive that is at least one of antibacterial and antiviral. In such embodiments, the additive is provided in the second layer at about 0.5% or more by weight. To provide the antiviral and/or antibacterial characteristics, the additive may include one or more of: cetrimide, parachlorometaxylenol, nitrofurazone, cetyl pyridium chloride, benzalknonium chloride, dimethyloctadecyl[3-(trimethoxysilyl)propyl]ammonium chloride, 5-chloro-2-(2,4-dichlorophenoxy)phenol (tricosan), silver acetate, silver citrate hydrate, silver sulfadiazine, chlorhexidine gluconate, isopropylmethylphenol, sulfadimethoxine, 3-iod-2 propinybutylcarbamate, zine pyrithion, o-phthalaldehyde, alexidine, ormetoprim, 1,3-bis(hydroxymethyl)-5.5-dimethylimidazolidin-2,4-dione, and 2-octyl-2H-isothiazol-3-one.

13. An object or device with a surface covered at least partially with the protective film of claim 1.

In some embodiments, the upper surfaces of the structures together form a non-planar contact surface for the protective film. In these embodiments, the structures may be configured as at least one of convex or concave linear lenses, convex or concave round lenses, convex or concave hexagonal lenses, and micro mirrors with tilt angles of at 3 degrees.

According to some aspects of the description, a method is provided for fabricating a protective film for providing antiviral and antibacterial protection. The method includes providing a first layer comprising a thermally elastic material. Significantly, the method also includes forming a second layer upon the first layer that includes a plurality of structures with surfaces for receiving at least one of viruses and bacteria. The structures of the second layer are configured to undergo elongation or contraction in response to the elongation or contraction of the first layer. Additionally, the structures are configured to damage the viruses or the bacteria upon movement of the surfaces during the elongation or contraction of the structures.

In some embodiments of the method, the second layer is formed of a film or layer of UV material, and the forming step involves a cast and cure of the layer of UV material. In these embodiments, the cast and cure may include use of a microstructure tool formed using gray scale lithography or binary imaging using a laser, LED, or E-beam photoresist process. Further, the microstructure tool can be fabricated by electroforming nickel from a photoresist formed in the photoresist process. In some other implementations, though, the forming step comprises embossing the structures on a surface of the first layer.

### BRIEF DESCRIPTION OF THE DRAWINGS

FIG. 1 is a schematic or functional block side view of an assembly of the present description showing a protective film (with its layers) applied over a surface of a device or structure to provide antimicrobial and/or antiviral protection;

FIG. 2 is a flow diagram for a method of manufacturing a protective film of the present description;

FIGS. 3A-6 illustrate top views of protective films showing use of microstructures in the form of lenses to produce a reduced-contact area outer surface for such films;

FIG. 7 illustrates a graph of pore density versus pore diameter for nanostructures that may be used to form the structures of the present description;

FIG. 8 is a top perspective view of a section of a protective film with nanostructures formed on a thermally elastic film/base layer;

FIGS. 9A-9D are examples of AAO films providing the microstructures on a variety of support films/layers of the present description; and

FIGS. 10A-10D illustrate four exemplary microstructure patterns that may be useful for fabricating or forming a structure-containing layer for a protective film of the present description.

### DETAILED DESCRIPTION

Briefly, embodiments described herein are directed toward protective films, methods of manufacturing such films, and devices or assemblies in which the films are used to provide protection against viruses and bacteria.

The inventors recognized that it is known in science that certain microstructures with three-dimensional (3D) shape can be “unfriendly” to microbes and viruses and make it problematic for attachment. These structures tend to be in the range of 1 to 5 microns in depth and have varying geometries. It is also well known in nature that certain small structures, such as exist on moth wings and in shark skin, have evolved into surfaces with physical shapes or structures that are naturally antimicrobial and antiviral so that they do not allow viruses and bacteria to grow or propagate (or at least are resistant to such growth and propagation). Further, though, the inventors recognized it is even more interesting that as some surfaces “move” in nature, such as in the wings of some insects, viruses and bacteria can be destroyed or torn apart.

With this in mind, the inventors worked to produce a protective film configured with a structure-carrying or filled layer, and structures or geometric shapes in this layer are caused to elongate and contract over time to act as “killers” of viruses and bacteria. As the structures/geometric shapes elongate and contract (or “move”) edges or surfaces of their components (walls and edges of recessed surfaces or canyons) contact viruses and bacteria received on the surfaces of the structures and rip or cut them into two-to-many pieces, which can cause them to die and/or fail to propagate as the viruses and bacteria cannon survive on these surfaces with such movement characteristics (e.g., elongation (or expansion of dimensions) and contraction (or shrinkage of dimensions)).

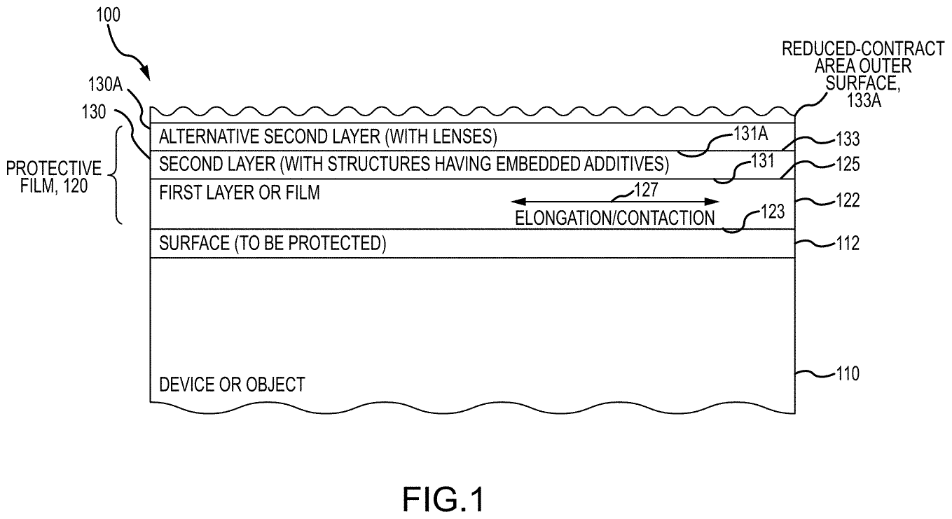

FIG. 1 is a schematic or functional block side view of an assembly 100 of the present description showing a protective film (with its layers) 120 applied over a surface 112 of a device or object 110 to provide antimicrobial and/or antiviral protection. The device or object 110 may take a wide variety of forms to practice the present invention. It may include nearly any object or device 110 with a surface 112 that is to be protected from viral or microbial buildup. For example, but not as a limitation, the surface 112 may be nearly any surface that is often touched by humans or users such as a touchscreen with the device 110 being nearly any electronic or computing device that may have such a screen. The device 110 may be a smartphone or other personal communication device with the surface being a display or touchscreen. The device or object 110 may be a countertop with the surface 112 being a top surface. The surface 112 may be all or a portion of a keypad with the device 110 taking the form of a security device or the like. The device 110 may be any of a number of medical devices, equipment, or tools or a medical implant with a surface 112 for which protection is desired.

The protective film 120 includes a first layer or film (or structure-supporting base or film or layer) 122. This first layer 112 is shaped and sized to extend over (or overlay) all or a large portion of the surface 112, with its bottom (typically planar) surface 123 abutting the surface 112. An adhesive (not shown) often will be used to attach the film 120 to the device surface 112 and would be disposed between the lower film surface 123 and the device surface 112. In some embodiments, the adhesive is chosen to retain the film 120 on the surface 112 but to allow ready removal of the film 120 without damaging the surface 112. Significantly, the first layer is formed of a material that contracts and elongates in response to changes in temperature as shown with arrow 127 (e.g., shrinks when cooled and expands when heated) so that its width, length, and thickness/height varies (e.g., X, Y, and Z dimensions change).

Additionally, and significantly, the protective film 120 includes a second layer or film 130 that is made up of microstructures chosen specifically for their geometry that is unfriendly to viruses and bacteria or other microbes. The second layer 130 is applied with its lower surface or side abutting and affixed to the upper side or surface 125 of the first layer or film 122. Au upper surface or side 133 may be exposed or facing the environment in which the film 120 is positioned to receive bacteria and viruses in the microstructures. Particularly, the microstructures are selected to have a geometry or pattern such that received viruses and bacteria are damaged (e.g., ripped or torn into pieces) when the microstructures are forced to elongate and contract with elongation and contraction 127 of the first layer 122 upon which they are supported or formed. The first layer 122 and the adhesive along with the second layer 130 are typically chosen so as to be translucent to transparent to light so that the surface 112 is readily visible through the film 120 and/or otherwise configured to support continuing functionality of the device 110 and surface 112 (e.g., with an overall thickness and flexibility to allow manipulation of the surface 112 and/or it to continue to act as a touchscreen).

In place of the second layer 120 describe above, the protective film 120 may instead (in place of so on top of first layer 122) includes an alternative second or upper layer or film 130A overlying the first layer 122. The alternative layer 130A has a lower surface or side 131A mated with the upper surface or side 125 of the first or support layer 120 (e.g., the alternative second layer 130A may be formed upon the first layer 122). The alternative second layer 130A has an upper/outer side or surface 133A, which is configured to have a reduced contact area than a mere planar surface. To this end, the surface 133A may be formed of a plurality or array of lenses to form an irregular cross sectional shape (non-planar) while also providing desired visibility of the surface 112, with the alternative second layer 130A also being formed of a translucent-to-transparent material.

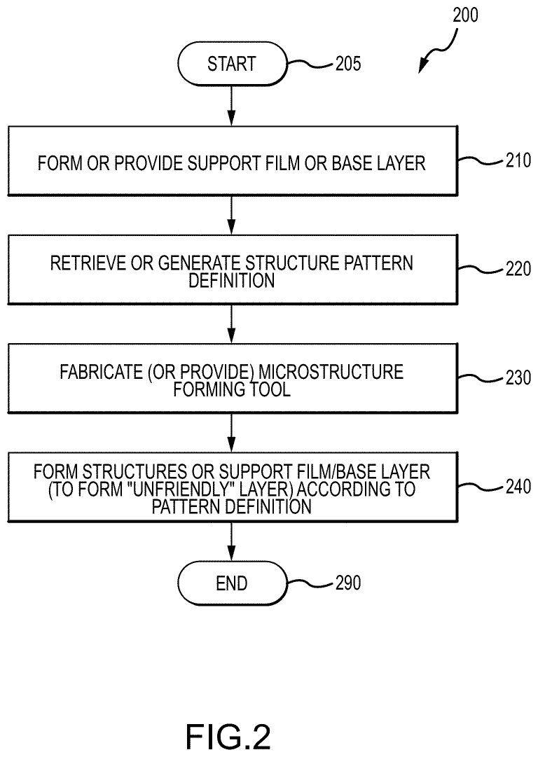

FIG. 2 is a flow diagram for a method 200 for manufacturing a protective film of the present description. The method 200 begins at 205, and this involve designing a protective film. It may desirable in step 205 to select the materials for each layer or sub-film of the protective film, the thicknesses of each film, and, in some cases, the type of antiviral or antimicrobial protection desired, which may affect the microstructures selected for the film to be fabricated (e.g., differing structures and/or differing amounts of elongation or contraction may be prove to be more effective against differing contaminants).

The method 200 continues at 210 with forming (or providing if already formed) a support film or base layer for the “unfriendly” microstructures. As discussed below, this film is formed of one or more materials chosen to provide a desired amount of elongation and contraction and/or to provide a minimum amount of such elongation and contraction with particular temperature changes. This dimensional change with a temperature change causes its dimensions (height, width, and thickness (in some cases)) to increase and decrease, which forces any microstructures supported on a surface of the film to also move (e.g., to contract and expand to close and open recessed surfaces, canyons/valleys, and the like in their bodies/patterns).

The method 200 continues at 220 with generating (or retrieving from memory or data storage) a structure pattern definition for use in forming a layer of microstructures on the film from step 210. A wide variety structures that are “unfriendly” to viruses and microbes may be chosen (e.g., from a database with definitions for differing microstructures) or one may be randomly (or based on input parameters) generated in step 220 as discussed below in more detail. The definition preferably defines microstructures with gaps or voids (e.g., recessed surfaces, canyons/valleys/cracks, and the like) for receiving viruses and microbials and also for enabling the microstructures to each be contracted and expanded with movements of the underlying or base layer from step 210. The shrinking and expanding of such gaps or voids can cause an action that damages the received viruses and microbes making the structure layer of the protective film hostile or unfriendly to such viruses and microbes.

The method 200 continues at 230 with fabrication (or providing of a previously fabricated) tool useful for forming the microstructures according to the pattern from step 220. The tool may be useful for casting microstructures, for embossing microstructures, or for forming the structures with a differing fabrication process. The method 200 continues at 240 with forming the microstructures, with the tool from step 230, on a surface of the support film/base layer from step 210 according to the pattern definition from step 220.

In some embodiments, step 240 involves, instead, applying or depositing a reduced-contact area layer over the film of step 220. This may involve attaching a prefabbed sheet including the structures, which may take the form of lenses, over the support film/layer or may involve fabricating a film with such lenses over the top or upper surface of the base or supporting film. The method 200 may then end at step 290, with the protective film being completed, which may involve the step of cutting or otherwise sizing and shaping a large sheet or roll of the protective film into pieces or sections of the protective film for application to surfaces of devices or objects (see FIG. 1) that may include using an adhesive to (at least temporarily) affix the protective film piece or section to the surface to be protected from contaminants.

The inventors recognized that microstructures of the desired proportions (e.g., from under 100 nm to several microns) can now be made with proper tools. For example, a forming tool can be formed (step 230 in method 200) in photoresists at these or even smaller scales using, for example, laser and electron beam emulsions in photoresists to make these patterns accurately and perfectly. It is believed that the desired size range for the microstructures (or the “sweet spot”) will be in the range of 1 to 10 microns in the Z axis (or in thickness) and in the range of 3 to 100 microns in the X and Y axes (in width and length in the microstructure layer).

To create a tool, for example, resists may be exposed, washed, and placed into electroforming tanks that can grow nickel (or another metal, a metal alloy, or other useful material) to produce an embossing tool with exacting precision. The nickel (or other material) tool is generally used (in step 240 of FIG. 2) to emboss films with either heat and pressure or, in some embodiments, is used to cast and cure to replicate microstructures by using UV acylates or other materials directly onto films (support films/bases from step 210 of method 200 of FIG. 2).

In step 240, the UV materials or other materials used to form the structures or structure-containing layer are mixed with antiviral and/or antibacterial agents or additives. This combination may then be cured in the desired pattern with or within the tool to form the microstructures. The agents or additives are, hence, embedded in the microstructures (e.g., the UV polymer used to form the microstructure-containing layer). During use, these antiviral and/or antibacterial agents often will bloom or migrate to the outer surfaces of each microstructure so as to come into direct contact with any viruses and bacteria received on or within the microstructures to further limit or even block their propagation or life on the protective film.

Further, to achieve the desired movement of the microstructures, preferred support or base layers/films on which to cast (or otherwise form) the microstructures are made of materials chosen for their thermal coefficient of expansion so as to provide relatively large amounts of expansion and contraction during a particular temperature change. Particularly, it may be desirable for the support film/layer to be formed of a material with a differential in the thermal coefficient of expansion from minimum to maximum of at least 10 and preferably more (i.e., at least 10 differential). For instance, the material chosen to form the support film/layer may be one chosen from Table 1 below, or another material useful for forming films not shown in the table, that has a differential of 10 or more in its thermal coefficient of expansion.

TABLE 1
Polymer/Material Options for Structure-Supporting Film/Layer

| | Min Value | Max Value |
|---|---|---|
| Polymer Name | (10⁻⁵/° C.) | (10⁻⁵/° C.) |
| PSU—Polysulfone | 5.00 | 6.00 |
| PSU, 30% Glass fiber-reinforced | 2.00 | 3.00 |
| PSU Mineral Filled | 3.00 | 4.00 |
| PTFE—Polytetrafluoroethylene | 7.00 | 20.00 |
| PTFE, 25% Glass Fiber-reinforced | 7.00 | 10.00 |
| PVC (Polyvinyl Chloride), 20% Glass Fiber- | 2.00 | 4.00 |
| reinforced | | |
| PVC, Plasticized | 5.00 | 20.00 |
| PVC, Plasticized Filled | 7.00 | 25.00 |
| PVC Rigid | 5.00 | 18.00 |
| PVDC—Polyvinylidene Chloride | 10.00 | 20.00 |
| PVDF—Polyvinylidene Fluoride | 8.00 | 15.00 |
| SAN—Styrene Acrylonitrile | 6.00 | 8.00 |
| SAN, 20% Glass Fiber-reinforced | 2.00 | 4.00 |
| SMA—Styrene Maleic Anhydride | 7.00 | 8.00 |
| SMA, 20% Glass Fiber-reinforced | 2.00 | 4.00 |
| SMA, Flame Retardant V0 | 2.00 | 6.00 |
| SRP—Self-reinforced Polyphenylene | 3.00 | 3.00 |
| UHMWPE—Ultra High Molecular Weight | 13.00 | 20.00 |
| Polyethylene | | |
| XLPE—Crosslinked Polyethylene | | |

While any of these materials may be useful in some cases or embodiments, it may be more useful to choose one from the group consisting of: polytetrafluoroethylene (PTFE), plasticized polyvinyl chloride (PVC), plasticized filled PVC, PVC rigid, and polyvinylidene chloride (PVDC). For example, it may be useful to provide a support layer/film fabricated of plasticized PVC because it has a differential in the thermal coefficient of expansion of 15 between minimum and maximum. In other embodiments, though, some other materials may be desirable because they are known to expand and contract with heat (e.g., to temperature above room temperature or the range of 60 to 75° F. or the like to higher temperatures), and these may include highly plasticized vinyl, polyethylene, and the like. These additional films, with only minor changes in temperature expand and contract several percentage points. Stated differently, materials useful for the supporting film/layer may be those that expand and contract in at least one dimension 3 to 5 percent or more in response to a temperature change of 5° C. or greater.

The linear coefficient ‘CLTE or α’ for plastic and polymer materials is calculated as:

α=ΔL/(L₀*ΔT)

where: α is coefficient of linear thermal expansion per degree Celsius; ΔL is change in length of test specimen due to heating or to cooling; L₀ is the original length of specimen at room temperature; and ΔT is temperature change, ° C., during test. Therefore, α is obtained by dividing the linear expansion per unit length by the change in temperature. When reporting the mean coefficient of thermal expansion, the temperature ranges must be specified. As the film moves with the changing temperatures, the microstructures supported thereupon elongate and contract. As this happens at the microscopic level, the contaminants within and on the microstructures are damaged such as by being ripped apart causing them to die in many cases.

As shown in FIG. 1, the protective film 120 may include an outer or second layer or film 130A that is specially configured to reduce the amount (or area) of contact between a human user and the film 120 when applied to device/object surface 112. Microstructures in the layer 130A (which may include antiviral or antimicrobial agents or additives as may layer 130) of protective film 120 can also work by decreasing the surface of the persons “touch” and allowing less contact with the skin in the structures (less surface area of the skin of a user touches the surface). Micro lenses both convex and concave can be effective as the microstructures for a protective film in limiting the growth of microbes, as well as unfriendly surfaces and structures that expand and contract for crushing microbes by using the principal of linear thermal elasticity.

These micro lenses (or lens-based microstructures) can be produced in a variety of ways including via cast UV or E-beam technology. In these fabrication processes, the lenses are formed by coating the UV material to the desired film (which may be PET, Polypropylene, acetate, or any clear film), and the UV material is cured while in contact with the structured tool that may be nickel, polymer, or copper as examples. The film/layer containing the lenses is then cured. In other embodiments, the lenses or microstructures are formed using extrusion. The microstructures in these embodiments of the protective films may take the form of round lenses, hexagonal lenses, or lenticular lenses (linear lenses). The scale of the lenses varies from up to about 100 microns in diameter and about 25 microns in depth or thickness to less than about 15 microns in diameter and about 6 microns in depth. The general preferred thickness of the lens or microstructure containing layer or film is about 10-15 microns with lenses (or microstructures) between about 25 microns and 60 microns in diameter.

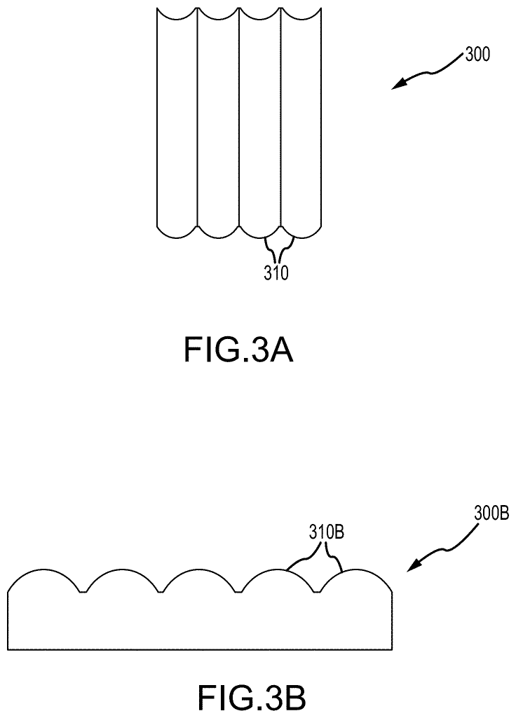

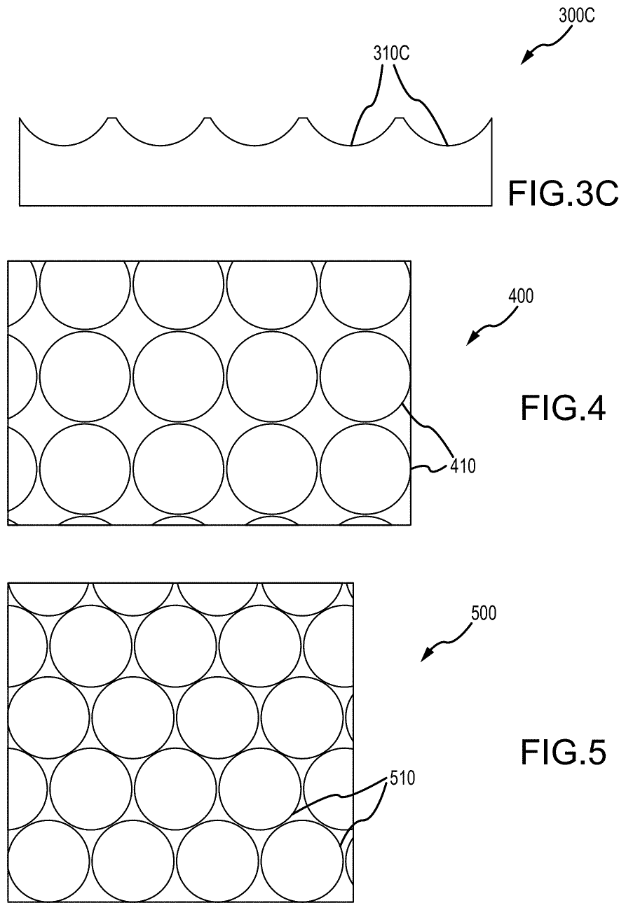

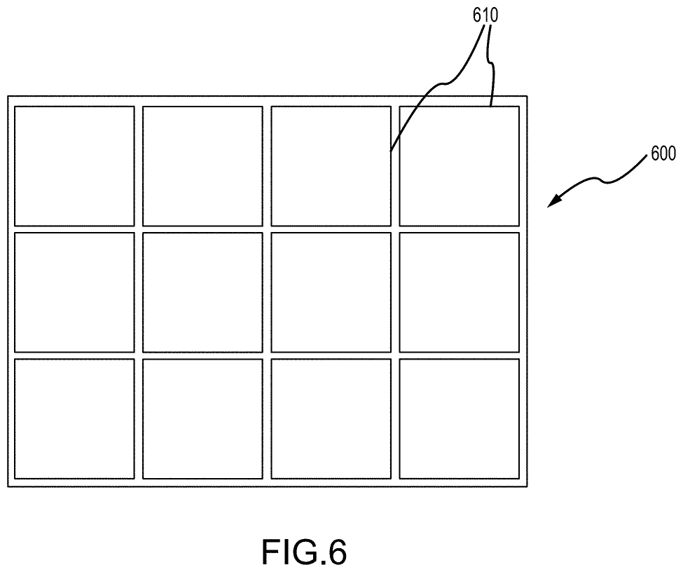

The lens-based microstructures may take a variety of shapes and forms to provide a reduced contact area outer layer of the protective film. FIG. 3A illustrates a top view of a protective film 300 illustrating an outer surface with reduced contact area provided by a plurality of linear or lenticular lenses 310. As shown in FIG. 3B, the lenticular or linear lenses 310B may be convex to implement the protective film 300B. Further, though, as shown in FIG. 3C, the lenticular or linear lenses 310C may be concave to implement the useful protective film 300C. In other cases, round lenses may be used as the microstructures and be provided on an outer surface of the protective film. This can be seen in FIG. 4 with protective film 400 with stacked round lenses 410, which may be concave or convex, and can be further seen in FIG. 5 with protective film 500 with hex packed lenses 510, which may be concave or convex. As noted above, the lenses 310, 410, and 510 may be formed to include an embedded antiviral and/or antimicrobial agent or additive.

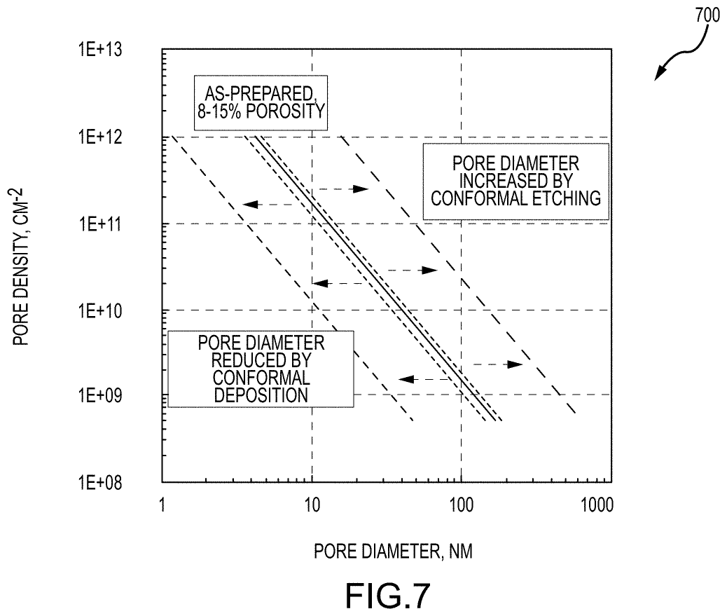

FIG. 6 illustrates a top view of another useful protective film 600 with microstructures in the form of micromirrors 610, with have a square shape in this embodiment. The structures 610 may be produced via cast and cure as described above on a clear film. The micromirrors 610 may range in size from about 15 to about 50 microns across. These structures 610 may have random tilt angles, and the mirrors 610 may all be tilted at least 3 degrees from horizontal to form less surface area (when compared with a planar surface) and, also, less friendly landscapes for microbes. Further, the mirrors 610 may be formed of a material with an antiviral and/or antimicrobial agent or additive as discussed above, and they may also take the shape and be fabricated as described in U.S. Pat. No. 10,317,691, which is incorporated by reference herein.

Further, the structures provided in the protective film may take the form of nanostructures, which may be defined as being structures with a largest dimension (width, length, height, diameter, or the like) under one micron and preferably under 200 nm. These structures are also, in some embodiments, chemically infused (or embedded with an agent that is antiviral and/or antimicrobial). These nanostructures may be formed so as to have a random patterns or more regular patterns with a preferred structure of about 50 to 100 nm width and length (X and Y axes) and a Z axis or depth of at least 50 nm but preferred, in some cases, to have a thickness or depth (or dimension in the Z axis) at least double the size of the dimension in either of the X axis or the Y axis.

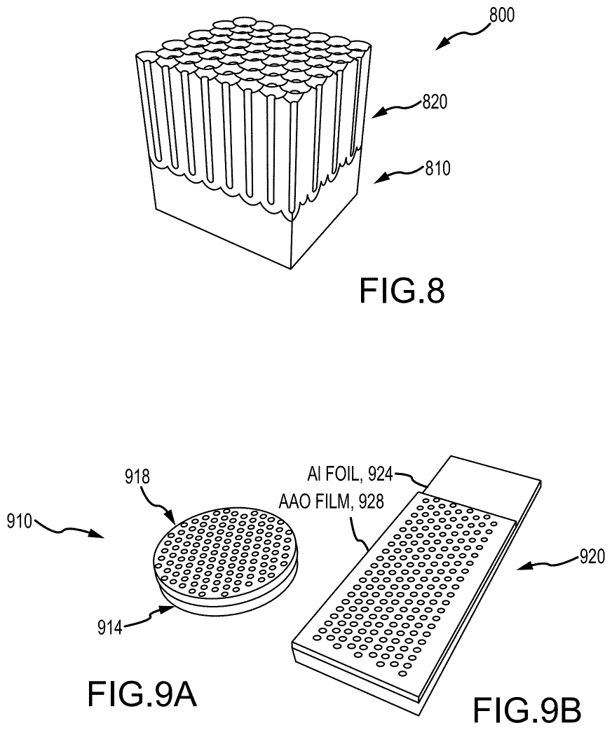

These nanostructures can be created via electron beam in a resist and then electroformed for a production tool for a cast and cure replication process. However, a more economical version of this tooling involves anodizing aluminum. In particular, it may be useful to form the structure-carrying film or layer of nanoporous anodic aluminum oxide (AAO) (also known as porous aluminum oxide (PAO) or nanoporous alumina membranes (NPAM)). AAO is a self-organized material with honeycomb-like structure formed by high density arrays of uniform and parallel nanopores. AAO can be formed by electrochemical oxidation (anodization) of aluminum in the conditions that balance the growth and the localized dissolution of aluminum oxide. In the absence of such dissolution, dense anodic alumina films are formed with limited thickness. The diameter of the nanopores can be controlled with great precision from as low as 5 nanometers to as high as several hundred nanometers, with pore length from few tens of nanometers to few hundred micrometers. FIG. 7 illustrates a graph of pore density versus pore diameter for nanostructures that may be used to form the structures of the present description such as with AAO. An exemplary layer of such structures may be defined by a pattern or grid with 1 micron squares having a Z-axis height or depth (or thickness) of about 3 microns.

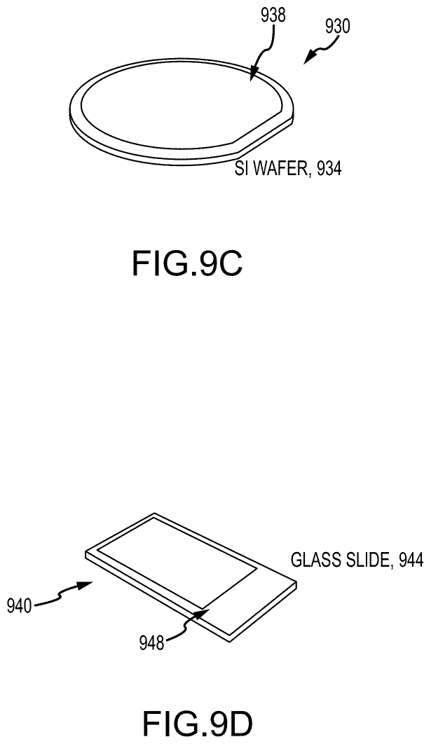

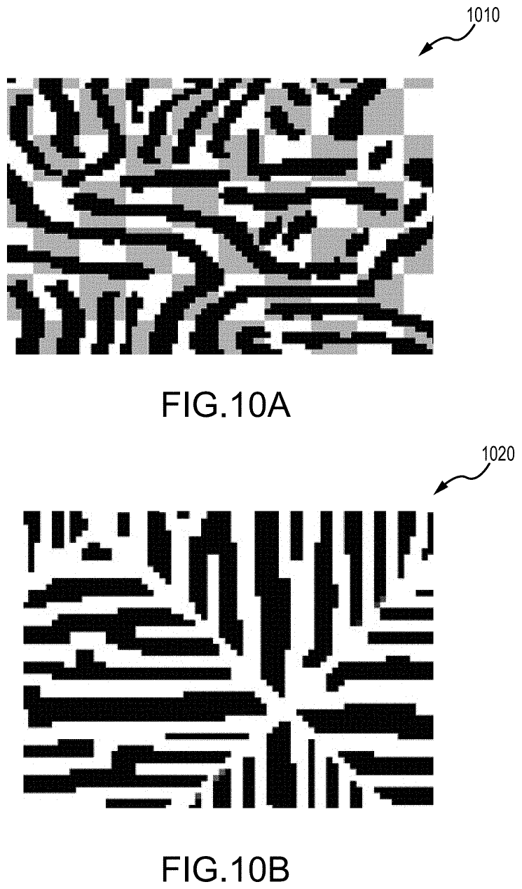

FIG. 8 is a top perspective view of a section of a protective film 800 with nanostructures formed in a structure-containing layer 820 on a thermally elastic film/base layer 810. FIGS. 9A-9D are examples of AAO films providing the microstructures on a variety of support films/layers of the present description. Particularly, FIG. 9A shows a protective film 910 made up of an Al foil/film 914 (but Ti or other materials may be used) upon which an AAO film (or another material such as anodic titanium oxide or the like useful for providing self-organized nanotubular films) is formed or provided to achieve a structure-containing or unfriendly layer 918 as described herein. FIG. 9B shows a protective film 920, similar to FIG. 9A, with an AAO film 928 provided to overlay an Al foil 924. FIG. 9C shows a protective film 930 that includes an AAO film 938 provided on a substrate/film 934 in the form of a Si wafer while FIG. 9D shows a protective film 940 that includes an AAO film 948 provided on a substrate/film 944 in the form of a glass layer or slide. In the examples of FIGS. 8-9D, the pore diameters in the forming tools (which may be thought of as self-organized AAO nanotemplates) may be in the range of 2.5 to 300 nm, and these could provide an interface that could be tailored for electrodeposition inside the pores

For the protective films described herein including the film 800 of FIG. 8 and films 910, 920, 930, and 940 of FIGS. 9A-9D, anodized aluminum can be engineered to make nano holes or nanowires as the requisite tool with heights up to a few microns and widths of in the range of about 50 to about 200 nm. These anodized aluminum pieces can be used to electroform nickel or as tools themselves in the cast and cure process to form the unfriendly structures or structure-containing layers upon a support film/layer. Positive and negative tools can be formed from these originations and effectively and accurately reproduced in cast and cure method in, for example, a roll-to-roll manufacturing process with infused UV materials (i.e., UV materials infused with antimicrobial and/or antiviral agents or additives). The films shown in these figures may also implemented as nanoporous AAO films integrated onto non-Al substrates, such as glass, sapphire, silicon wafers, quartz, and polymers, that may be electroformed to produce tools suitable for electroforming and production materials to fabricate the structures or structure-containing layers of the present description.

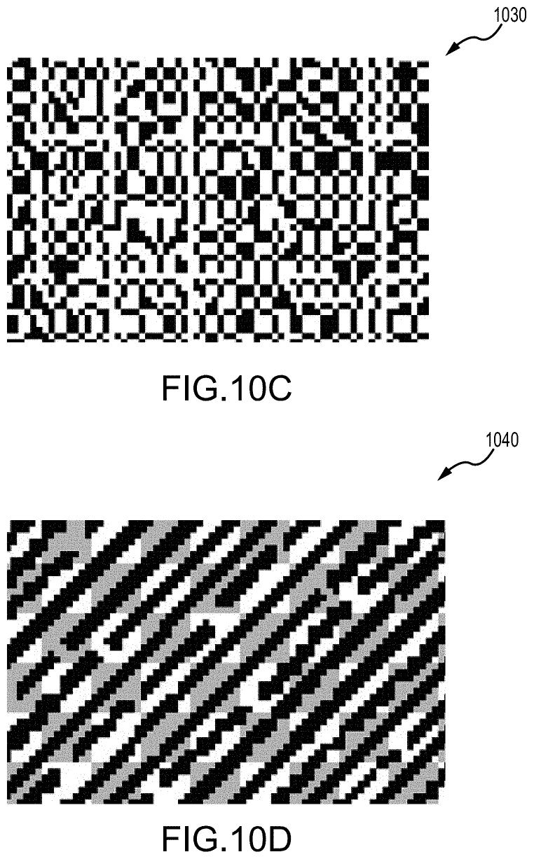

As noted above, the particular pattern of the structures used in a protective film may vary to practice the invention or to create an unfriendly environment for virus and/or bacteria. FIGS. 10A-10D illustrate four exemplary microstructure patterns 1010, 1020, 1030, and 1040 that may be useful for fabricating or forming a structure-containing layer for a protective film. The geometry for microstructures below are larger scale structures as compared to the nanostructures discussed above with reference to FIGS. 8-9D. These can be made, in some embodiments, via laser resist coatings and then electroformed into production nickel tooling that can be used in the cast and cure of a structure-containing film/layer upon a thermally-elastic support film/base. The scale for the structure patterns 1010 and 1040 of FIG. 10A and 10D, for example, which would be repeated numerous times to form a protective film, may be that each small square in the pattern is 1 micron. Hence, the width of the structures in the patterns is about 2 to 5 microns while the lengths are in the range of 2 to 50 microns or more.

It may be useful to further describe and define the antibacterial and antiviral structures to be included in protective films of the present description. Generally, these structures are in the range of about 1 micron to 50 microns wide but are preferably about 1-15 microns wide and are between 10 and 100 microns long. The structures are generally between about 1 micron and 10 microns high or thick with a preference of about 1-3 microns in the Z axis. They may be patterns or randomly generated structures or repeated patterns as described with reference to FIGS. 10A-10D.

In some embodiments, the structures may be designed or configures such that they may or may not elongate in one axis causing one axis to shrink because such selective elongation and contraction may provide the more unfriendly structures or ones that are the most destructive structures to viruses and/or bacteria. It is the elongation and contraction that can kill the viruses and bacteria and make the surface uninhabitable for bacteria and viruses (with the thermal coefficient of expansion and contraction of the base film holding the structures).

The use of a film that can elongate and contract is preferred for devices, phones, screens, and keypads or any area with a temperature deviation of at least around 5° C. in use or with a change of environment. To form these unique protective films, the structures can be applied on non-elastic or elastic films, implants, injection molded objects, or other objects and/or devices.

Various additives or agents may be mixed with the material used to form the structures or structure-containing layer of the protective film. In some embodiments, the additives or agents are chosen for their antiviral and/or antimicrobial characteristics, and they may be provided at about 0.5% or more by weight (e.g., into the UV cast and cure materials or the like). Examples of some useful additives or agents that may be used to produce protective films include one or more of the following: cetrimide, parachlorometaxylenol, nitrofurazone, cetyl pyridium chloride, benzalknonium chloride, dimethyloctadecyl[3-(trimethoxysilyl)propyl]ammonium chloride, 5-chloro-2-(2,4-dichlorophenoxy)phenol (tricosan), silver acetate, silver citrate hydrate, silver sulfadiazine, chlorhexidine gluconate, isopropylmethylphenol, sulfadimethoxine, 3-iod-2 propinybutylcarbamate, zine pyrithion, o-phthalaldehyde, alexidine, ormetoprim, 1,3-bis(hydroxymethyl)-5.5-dimethylimidazolidin-2,4-dione, and 2-octyl-2H-isothiazol-3-one.

In some preferred embodiments, the structures are formed using antiviral and/or antibacterial agents or additives in percentages of 0.25% to 2% by weight as additives, e.g., in UV coatings that are cured while applied to support films, layers, or substrates. The resulting protective film may be designed to be used on surfaces as an antiviral and or antibacterial film protectant. The UV coating or material containing the structures and additive/agent may be applied in a roll to roll environment. Additionally, in some implementations, the formation of microstructures is performed to provide structures with Z axes (or a thickness, depth, or height) in the range of 1 to 10 microns and X and Y axes (or widths and lengths) selected to be 1 to 30 microns and 1 to 100 microns, respectively (or vice versa). The protective films (or sections or pieces thereof) are placed to inhibit the growth of bacteria and or viruses and make an environment unfriendly to the viruses and bacteria.

The method of forming microstructures may involve using a UV cast and cure process in sheet or roll to roll form by curing clear films through the film while in contact with a microstructure tool. In some embodiments, the method of forming includes embossing these structures with heat and pressure or only pressure. In other embodiments, injection molding may be used to form the structures of the protective films taught herein. The forming method may include creating the microstructures in a graphic file, and, then further in some cases, using gray scale lithography or binary imaging using a laser, LED, or E-beam photo resist process to form a fabrication tool for the structure pattern defined in the graphic file. To this end, using the photoresist, electroforming nickel or other tooling may be created from the photoresist for cast and cure manufacturing.

The microstructures, e.g., the pattern defining the microstructures in the graphic file, may be randomly generated in a program so that they do not follow repeating patterns. In other cases, though, the formation of microstructures creates microstructures or patterns of microstructures that are not substantially parallel and are not repeating patterns within 50-100 microns of the X and Y axes.

The application of the microstructures in a cast and cure or embossing with heat and pressure to films may be completed with films (e.g., structure-supporting films or base layers) that have linear thermal coefficient differentials of at least 5 (e.g., as seen in Table 1) and/or that have thermal expansion or contraction in at least one dimension or axis of at least 0.01% with a temperature differential of 5° C. or more.

The protective films may have a wide variety of uses. For example, micro structured films may be provided on PDA devices and screens of all types as a deterrent and or method to protect the spread of bacteria and viruses. The protective films, with UV microstructures with embedded antiviral and/or antibacterial chemicals that may be provided on thermally elastic films or base layers, may be used to provide antibacterial and antiviral protection on devices, phones, and screens. The protective films may be provided as thermally elastic films embossed with microstructures made from UV materials and embedded with antiviral and or antibacterial agents may be used on counters, doors, windows, and other items touched frequently by consumers or people in public places or private businesses or homes. The surfaces may be covered (at least partially) by the protective film may be used on surfaces to prevent the spread of Covid 19 or any other virus or bacteria. The use of microstructures made from UV cast polymers on any film (thermally elastic or not) to prevent viruses and bacteria from attaching or growing is believed unique and new. However, in some cases, the protective films may be formed without antiviral or antibacterial additives (embossed or made with cast and cure) and provided on any surface including glass to control bacteria and viruses. The new protective films may be used on nearly any device or object including on medical devices and body implants of any kind.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

The microstructures discussed above may be structures that are 50 microns or less. In some preferred implementations, these microstructures may be implemented as convex lens structures (e.g., linear, round, hexagonal, square, or round lenses). In some particular cases, the convex lenses form a “V” shape and intersect with the adjoining lens such that microbes can be trapped, crushed, and surrounded with the chemically infused materials (not just from a level surface) during “movement” or elongation and contraction. This design, combined with use of underlying films possessing high linear coefficients of expansion can crush the microbes or viruses.

In other specific implementations, the microstructures may be formed as a concave structure. Then, the “troughs” in a linear lens, for example, are provided to trap bacteria and microbes, and the curvatures of the surface increase the contact to the microbes (of the infused surface). Further, in the round and other-shaped lens designs, the concave structures form a “pocket” or cell that increases the contact of the infused material. Further, the intersections of these lens shapes may be configured or arranged to form a “point” or a linear “point” that can pierce and destroy microbes and viruses. Further, these shapes can potentially crush viruses and microbes with the supporting or underlying film's elasticity and “movement.” The depth of the lenses and lens cusps in these microstructures typically would range from about 2 microns to about 15 microns. The lens diameters may range from about 8 microns to about 70 microns.

Other non-lens structures could also be utilized as the “structures” as this term is used herein, and these non-lens structures may be any structure that is “random or “pseudo random” and has a size range in width of about 3-15 microns and a depth of between 1 and 4 microns and a length of up to about 35 microns. Further, the intersection in the Z axis or depth preferably may form a “V” shape or other shape but not a flat surface at the bottom in order for the structures to properly perform and act to create unfriendly surfaces with elongation and contraction of the supporting/underlying film.

We claim:

1. A protective film providing antiviral and antibacterial protection, comprising:
a first layer comprising a thermally elastic material, wherein the first layer undergoes elongation or contraction when the protective film is exposed to a temperature differential; and
a second layer disposed upon the first layer comprising a plurality of structures with surfaces for receiving at least one of viruses and bacteria,
wherein the structures of the second layer undergo elongation or contraction in response to the elongation or contraction of the first layer, and
wherein the structures are configured to damage the viruses or the bacteria upon movement of the surfaces during the elongation or contraction of the structures.

2. The protective film of claim 1, wherein the structures each have a height in the range of 1 to 10 microns, a width in the range of 1 to 30 microns, and a length in the range of 1 to 100 microns.

3. The protective film of claim 2, wherein the structures have a randomly generated geometry and are arranged in a non-repeating pattern.

4. The protective film of claim 2, wherein the structures are arranged in nonparallel and non-repeating patterns within 50 to 100 microns of the X and Y axes.

5. The protective film of claim 1, wherein the second layer comprises a layer of nanoporous anodic aluminum oxide (AAO). 6 The protective film of claim 1, wherein the thermally elastic material is a material with a linear thermal coefficient differential of at least 5° C.

7. The protective film of claim 6, wherein the thermally elastic material comprises at least one of: polytetrafluoroethylene (PTFE), plasticized polyvinyl chloride (PVC), plasticized filled PVC, PVC rigid, and polyvinylidene chloride (PVDC).

8. The protective film of claim 1, wherein the thermally elastic material is a material having thermal expansion or contraction in at least one dimension or axis of at least 0.01% when the temperature differential is 5° C. or greater.

9. The protective film of claim 1, wherein the second layer is formed of a film or layer of UV material.

10. The protective film of claim 1, wherein the second layer is formed of a material including an additive that is at least one of antibacterial and antiviral.

11. The protective film of claim 10, wherein the additive is provided in the second layer at about 0.5% or more by weight.

12. The protective film of claim 10, wherein the additive comprises one or more of: cetrimide, parachlorometaxylenol, nitrofurazone, cetyl pyridium chloride, benzalknonium chloride, dimethyloctadecyl [3-(trimethoxysilyl)propyl]ammonium chloride, 5-chloro-2-(2,4-dichlorophenoxy)phenol (tricosan), silver acetate, silver citrate hydrate, silver sulfadiazine, chlorhexidine gluconate, isopropylmethylphenol, sulfadimethoxine, 3-iod-2 propinybutylcarbamate, zine pyrithion, o-phthalaldehyde, alexidine, ormetoprim, 1,3-bis(hydroxymethyl)-5.5-dimethylimidazolidin-2,4-dione, and 2-octyl-2H-isothiazol-3-one.

13. An object or device with a surface covered at least partially with the protective film of claim 1.

14. A protective film providing antiviral and antibacterial protection, comprising:
a support film; and
a plurality of structures, with surfaces for receiving at least one of viruses and bacteria, formed on the support film,
wherein upper surfaces of the structures form a non-planar contact surface for the protective film, and
wherein the structures are formed of a material including an additive that is at least one of antibacterial and antiviral.

15. The protective film of claim 14, wherein the additive is provided in the second layer at about 0.5% or more by weight.

16. The protective film of claim 15, wherein the additive comprises one or more of: cetrimide, parachlorometaxylenol, nitrofurazone, cetyl pyridium chloride, benzalknonium chloride, dimethyloctadecyl[3-(trimethoxysilyl)propyl]ammonium chloride, 5-chloro-2-(2,4-dichlorophenoxy)phenol (tricosan), silver acetate, silver citrate hydrate, silver sulfadiazine, chlorhexidine gluconate, isopropylmethylphenol, sulfadimethoxine, 3-iod-2 propinybutylcarbamate, zine pyrithion, o-phthalaldehyde, alexidine, ormetoprim, 1,3-bis(hydroxymethyl)-5.5-dimethylimidazolidin-2,4-dione, and 2-octyl-2H-isothiazol-3-one.

17. The protective film of claim 14, wherein the structures comprises at least one of convex or concave linear lenses, convex or concave round lenses, convex or concave hexagonal lenses, and micro mirrors with tilt angles of at 3 degrees.

18. An object or device with a surface covered at least partially with the protective film of claim 4.

19. A method of fabricating a protective film for providing antiviral and antibacterial protection, comprising:
providing a first layer comprising a thermally elastic material; and
forming a second layer upon the first layer comprising a plurality of structures with surfaces for receiving at least one of viruses and bacteria,
wherein the structures of the second layer are configured to undergo elongation or contraction in response to the elongation or contraction of the first layer, and
wherein the structures are configured to damage the viruses or the bacteria upon movement of the surfaces during the elongation or contraction of the structures.

20. The method of claim 19, wherein the structures each have a height in the range of 1 to 10 microns, a width in the range of 1 to 30 microns, and a length in the range of 1 to 100 microns and wherein the structures have a randomly generated geometry and are arranged in a non-repeating pattern or are arranged in nonparallel and non-repeating patterns within 50 to 100 microns of the X and Y axes.

21. The method of claim 19, wherein the thermally elastic material is a material with a linear thermal coefficient differential of at least 5° C.

22. The method of claim 19, wherein the thermally elastic material is a material having thermal expansion or contraction in at least one dimension or axis of at least 0.01% when the temperature differential is 5° C. or greater.

23. The method of claim 19, wherein the second layer is formed of a film or layer of UV material and wherein the forming step comprises a cast and cure of the layer of UV material.

24. The method of claim 23, wherein the cast and cure comprises use of a microstructure tool formed using gray scale lithography or binary imaging using a laser, LED, or E-beam photoresist process.

25. The method of claim 24, wherein the microstructure tool is fabricated by electroforming nickel from a photoresist formed in the photoresist process.

26. The method of claim 19, wherein the forming step comprises embossing the structures on a surface of the first layer.

27. The method of claim 19, wherein the second layer is formed of a material including an additive that is at least one of antibacterial and antiviral.

28. The method of claim 27, wherein the additive is provided in the second layer at about 0.5% or more by weight.

29. The method of claim 27, wherein the additive comprises one or more of: cetrimide, parachlorometaxylenol, nitrofurazone, cetyl pyridium chloride, benzalknonium chloride, dimethyloctadecyl[3-(trimethoxysilyl)propyl]ammonium chloride, 5-chloro-2-(2,4-dichlorophenoxy)phenol (tricosan), silver acetate, silver citrate hydrate, silver sulfadiazine, chlorhexidine gluconate, isopropylmethylphenol, sulfadimethoxine, 3-iod-2 propinybutylcarbamate, zine pyrithion, o-phthalaldehyde, alexidine, ormetoprim, 1,3-bis(hydroxymethyl)-5.5-dimethylimidazolidin-2,4-dione, and 2-octyl-2H-isothiazol-3-one.
